(19) United States
(12) Patent Application Publication
(10) Pub. No.: US 2022/0108452 A1
(43) Pub. Date: Apr. 7, 2022

(54) METHOD AND DEVICE FOR IMAGE PROCESSING, ELECTRONIC DEVICE AND STORAGE MEDIUM

(71) Applicant: SHANGHAI SENSETIME INTELLIGENT TECHNOLOGY CO., LTD., Shanghai (CN)

(72) Inventors: Lei Xiang, Shanghai (CN); Yu Wu, Shanghai (CN); Liang Zhao, Shanghai (CN); Yunhe Gao, Shanghai (CN)

(21) Appl. No.: 17/553,997

(22) Filed: Dec. 17, 2021

Related U.S. Application Data
(63) Continuation of application No. PCT/CN2020/079544, filed on Mar. 16, 2020.

(30) Foreign Application Priority Data
Jul. 29, 2019 (CN) 201910690342.3

(51) Int. Cl. G06T 7/00; G06T 7/11; G06V 10/764; G06V 10/77; G06T 3/40; G06V 10/80

(52) U.S. Cl. CPC G06T 7/0012; G06T 7/11; G06V 10/764; G06T 2207/30008; G06T 3/40; G06V 10/806; G06T 2207/10081; G06V 10/7715

(57) ABSTRACT

A method and device for image processing, an electronic device and a storage medium are disclosed. The method includes: acquiring an image sequence to be processed; obtaining a target image sequence section by determining, in the image sequence to be processed, an image sequence section where a target image is located; and determining an image region corresponding to at least one image feature class in the target image sequence section by segmenting the target image in the target image sequence section.

### CROSS-REFERENCE TO RELATED APPLICATION

This is a continuation of International Application No. PCT/CN2020/079544, filed on Mar. 16, 2020, which claims benefit of priority to Chinese Patent Application No. 201910690342.3, filed on Jul. 29, 2019 and entitled “Method and Device for Image Processing, Electronic Device and Storage Medium”. The contents of International Application No. PCT/CN2020/079544 and Chinese Patent Application No. 201910690342.3 are incorporated herein by reference in their entireties.

### BACKGROUND

An injury scale of a skeletal injury is relatively high in unintentional injuries. For example, a high-strength trauma caused by falling from a height in an accident such as a traffic accident may cause a skeletal injury such as fracture or fissure fracture to further cause shock and even death of a patient. A medical imaging technology plays a very important role in skeletal diagnosis and therapy. A three-dimensional Computed Tomography (CT) image may present an anatomy structure and injury conditions of a skeletal region. Analysis of a CT image is favorable for the aspects of a skeletal anatomy structure, surgical planning, postoperative recovery evaluation and the like.

At present, analysis for a CT image of a skeleton may include segmentation of a skeletal region, and a skeletal region in each CT image needs to be positioned manually or segmented manually.

### SUMMARY

The disclosure relates to the technical field of computers, and particularly to a method and device for image processing, an electronic device and a storage medium.

According to an aspect of the disclosure, provided is a method for image processing, including: acquiring an image sequence to be processed; obtaining a target image sequence section by determining, in the image sequence to be processed, an image sequence section where a target image is located; and determining an image region corresponding to at least one image feature class in the target image sequence section by segmenting the target image in the target image sequence section.

According to an aspect of the disclosure, provided is a device for image processing including: an acquisition module, configured to acquire an image sequence to be processed; a determination module, configured to obtain a target image sequence section by determining, in the image sequence to be processed, an image sequence section where a target image is located; and a segmentation module, configured to determine an image region corresponding to at least one image feature class in the target image sequence section by segmenting the target image in the target image sequence section.

According to an aspect of the disclosure, provided is an electronic device, including: a processor; and a memory, configured to store processor-executable instructions, wherein the processor is configured to: acquire an image sequence to be processed; obtain a target image sequence section by determining, in the image sequence to be processed, an image sequence section where a target image is located; and determine an image region corresponding to at least one image feature class in the target image sequence section by segmenting the target image in the target image sequence section.

According to an aspect of the disclosure, provided is a non-transitory computer-readable storage medium having computer program instructions stored thereon, wherein the computer program instructions, when being executed by a processor, causes the processor to implement a method for image processing, the method including: acquiring an image sequence to be processed; obtaining a target image sequence section by determining, in the image sequence to be processed, an image sequence section where a target image is located; and determining an image region corresponding to at least one image feature class in the target image sequence section by segmenting the target image in the target image sequence section.

According to an aspect of the disclosure, provided is a computer program a computer-readable code that, when running in an electronic device, enables a processor in the electronic device to execute the method for image processing.

It is to be understood that the above general description and the following detailed description are only exemplary and explanatory and are not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 illustrates a flowchart of a method for image processing according to embodiments of the disclosure.

FIG. 2 illustrates a flowchart of preprocessing an image sequence according to embodiments of the disclosure.

FIG. 3 illustrates a flowchart of determining a target image sequence section according to embodiments of the disclosure.

FIG. 4 illustrates a flowchart of determining an image region corresponding to each image feature class in a target image according to embodiments of the disclosure.

FIG. 5 illustrates a block diagram of an example of a neural network structure according to an embodiment of the disclosure.

FIG. 6 illustrates a flowchart of an example of training the neural network according to embodiments of the disclosure.

FIG. 7 illustrates a block diagram of a device for image processing according to embodiments of the disclosure.

FIG. 8 illustrates a block diagram of an example of an electronic device according to embodiments of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is illustrated in the drawings, the drawings are not necessarily drawn to scale, unless otherwise specified.

Herein, special term “exemplary” means “used as an example, embodiment or exemplarily”. Herein, any embodiment described to be “exemplary” is not necessarily explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple items, or any combination of at least two of multiple items. For example, including at least one of A, B and C may represent including any one or more elements selected from a set composed by A, B and C.

In addition, for describing the disclosure better, many specific details are presented in the following detailed description. It is understood by those skilled in the art that the disclosure may still be implemented even without some specific details. In some examples, methods, means, components and circuits well known to those skilled in the art are not described in detail, to highlight the subject of the disclosure.

In the embodiments of the disclosure, an image sequence to be processed may be acquired, and then a target image sequence section is obtained by determining, in the image sequence to be processed, an image sequence section where a target image is located, so that image processing may be performed on the target image in the determined target image sequence section, and the workload of image processing may be reduced. Then, the target image in the target image sequence section may be segmented to determine an image region corresponding to at least one image feature class in the target image in the target image sequence section, so that image regions of different image feature classes in the target image may be automatically segmented. For example, a skeletal region in a CT image may be segmented, and human resources may be saved.

According to the image processing solution provided in the embodiments of the disclosure, a target image sequence section where a target image with a target image feature is located in an acquired image sequence may be determined, so that image processing may be performed on the target image in the target image sequence section rather than performed on each image in the image sequence. The workload in an image processing may be reduced, and the efficiency of image processing may be improved. Then, the target image in the determined target image sequence section is segmented to determine an image region corresponding to each image feature class in the target image. Herein, in a process of determining the image region corresponding to at least one image feature class, the target image may be processed by use of a neural network, and relative position information may be combined, so that the determined image region corresponding to each image feature class in the target image is more accurate, and obvious errors in a segmentation result are avoided.

The image processing solutions provided in the embodiments of the disclosure are applied to application scenarios such as image classification and image segmentation, or medical images in the medical field, e.g., labeling a pelvic region in a CT image. In related technologies, labeling the pelvic region is operated by manual in most situations, and a labeling process is time-consuming and deviations easily occur. In some semi-supervised means of pelvic region labeling, a seed point of pelvic region labeling needs to be selected by manual, and a wrong label needs to be corrected by manual. Such labeling process is also time-consuming, for example, labeling a three-dimensional CT image needs more than ten minutes. While, a pelvic region is determined rapidly and accurately through the image processing solution provided in the embodiments of the disclosure, which provides an effective reference for diagnosis of a patient.

The image processing solution provided in the disclosure will be described below through embodiments.

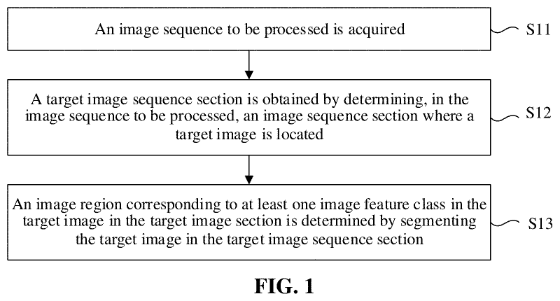

FIG. 1 illustrates a flowchart of a method for image processing according to embodiments of the disclosure. The method for image processing may be executed by a terminal device, a server or others image processing devices. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device or the like. In some possible implementations, the method for image processing may be implemented by a processor calling computer-readable instructions stored in a memory. The method for image processing according to the embodiments of the disclosure will be described below with an example that a device for image processing serves as a subject of execution.

As illustrated in FIG. 1, the method for image processing includes the following steps:

Step S11, acquiring an image sequence to be processed.

In some embodiments of the disclosure, the image sequence includes at least two images, and each image in the image sequence is arranged according to a preset arrangement rule to form the image sequence. The preset arrangement rule may include a temporal arrangement rule and/or a spatial arrangement rule. For example, multiple images are sorted to form the image sequence according to a sequence of time when the images are acquired, or sorted to form the image sequence according to spatial coordinates of positions where the images are acquired.

For example, the image sequence is a group of CT images obtained by scanning a patient with CT device. The acquisition time of each CT image is different, the image sequence is formed based on the obtained CT images according to the acquisition time of the CT images. Each CT image in the image sequence corresponds to different body parts.

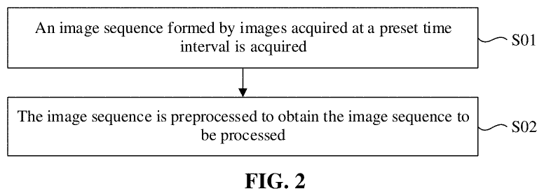

FIG. 2 illustrates a flowchart of preprocessing an image sequence according to embodiments of the disclosure.

In some embodiments of the disclosure, the image sequence to be processed is a preprocessed image sequence. As illustrated in FIG. 2, before S11, the method further comprises the following steps:

Step S01, acquiring an image sequence formed by images acquired at a preset time interval.

Step S02, preprocessing the image sequence to obtain the image sequence to be processed.

In some embodiments of the disclosure, the images in the image sequence are sorted according to the temporal arrangement rule, and images are acquired in a preset acquisition period and the image sequence are formed from a group of images acquired according to the acquisition time. Each image in the image sequence is preprocessed to obtain the image sequence after preprocessing. The preprocessing includes operations such as direction correction, exceptional pixel removal, pixel normalization and center cropping. By the preprocessing, irrelevant information in the images in the image sequence is reduced, and useful relevant information in the images is enhanced.

In some embodiments of the disclosure, when obtaining the image sequence to be processed by preprocessing the image sequence to, the direction correction is performed on each image in the image sequence to obtain the image sequence to be processed according to a respective direction identifier of the image in the image sequence. Herein, the images carry acquisition related information when the image in the image sequence is acquired. For example, when the image carries the acquisition related information such as the acquisition time of the image and an acquisition direction of the image, the direction correction is performed on the image in the image sequence according to the acquisition direction of the image, so that the image is oriented in a preset direction. Under the condition that an acquisition direction of the CT image is represented as a coordinate axis, the CT image is rotated to the preset direction, that is, the coordinate axis of the CT image, an x axis or a y axis, is parallel to the preset direction such that the CT image displays the cross section of a human body.

In some embodiments of the disclosure, when obtaining the image sequence to be processed by preprocessing the image sequence, the images in the image sequence are converted into images with a preset size, and then the image sequence to be processed is obtained by performing center cropping on the images with the preset size. Herein, resampling or edge cropping is performed on the image to convert sizes of the images in the image sequence into a uniform size, and then the images with the preset size are center cropped to remove the irrelevant information from the image and retain the useful relevant information in the image.

In some embodiments of the disclosure, under the condition that the image sequence is a CT image sequence, when preprocessing the CT image sequence, the direction correction is performed on one or more CT images in the CT image sequence to ensure that the CT images present a cross-sectional structure of a human body. The pixel values of pixels in the CT image are within a section [4,024, 1,024] by removing outliers in the CT image, and the pixel values of the pixels in the CT image are normalized to be within [−1, 1]. The CT image is resampled to a uniform size such as 0.8*0.8*1 mm³. For example, the CT image is center cropped to a CT image with 512*512 pixels. As to an image position less than 512*512 pixels, the pixel value is set to a preset value, e.g., −1. The above-mentioned preprocessing methods are combined arbitrarily.

Step S12, obtaining a target image sequence section by determining, in the image sequence to be processed, an image sequence section where a target image is located in the image sequence to be processed.

In some embodiments of the disclosure, an image feature of each image in the image sequence is extracted, or the image features of at least two images are extracted. Then, the target image with a target image feature in the image sequence is determined according to the extracted image features. A position where the target image is arranged in the image sequence is determined. The target image sequence section where the target image with the target image feature is located is obtained according to arrangement positions of two target images which are farthest away from each other in the target images. Herein, image feature extraction is performed on the images in the image sequence through a neural network, the target image with the target image feature is determined according to the extracted image features. Further, the target image sequence section where the target image is located is determined. The target image sequence section is a part of the image sequence to be processed. For example, if the image sequence includes 100 images and the arrangement positions of the target image is in an image sequence section of 10-20, the image sequence section is the target image sequence section. In some implementations, the image in the image sequence is matched with a preset image to obtain a matching result, and then the image sequence section where the target image is located is determined according to the matching result. For example, an image with a matching result greater than 70% is determined as a target image, and an image sequence section where the target image is located is determined as the target image sequence section.

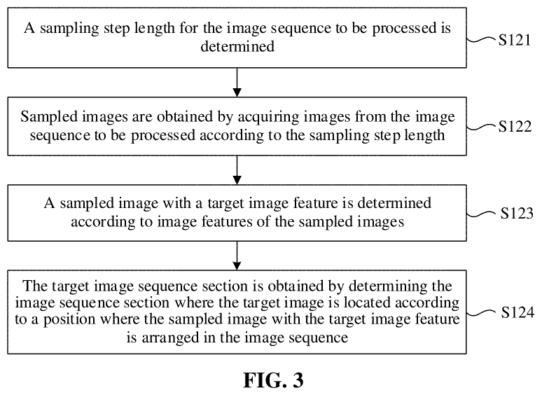

FIG. 3 illustrates a flowchart of determining an image sequence section according to embodiments of the disclosure.

In some embodiments of the disclosure, S12 includes the following steps:

Step S121, determining a sampling step length for the image sequence to be processed;

Step S122, obtaining sampled images by acquiring images from the image sequence to be processed according to the sampling step length;

Step S123, determining a sampled image with a target image feature according to image features of the sampled images;

Step S124, obtaining the target image sequence section by determining, according to a position where the sampled image with the target image feature is arranged in the image sequence, the image sequence section where the target image is located.

In such a manner, the target image sequence section where the target image is located may be determined rapidly, the workload in image processing may be reduced, and the efficiency of image processing may be improved.

In one embodiment of the disclosure, the sampling step length is set according to an actual application scenario. For example, with 30 images as the sampling step size, an image in the image sequence is obtained at an interval of the sampling step length and the obtained image is used as the sampled image. As to the obtained sampled image, image features of the sampled image are extracted through the neural network. The sampled image with the target image features is determined, and then the arrangement position of the sampled image with the target image feature in the image sequence is determined. An image sequence section is determined by arrangement positions corresponding to two sampled images with the target image feature, and the obtained largest image sequence section among multiple image sequence sections is determined as the target image sequence section where the target image is located. Since the image sequence is arranged according to the preset arrangement rule, an image in the target image sequence section formed by the sampled images with the target image feature also contains the target image feature and is a target image. In some embodiment s, the finally determined image sequence section includes all target images by extending upper and lower boundaries of the image sequence section.

By way of example, under the condition that the image sequence is a CT image sequence, CT images in the CT image sequence are sampled at an equal interval with a sampling step length of 30 images. That is, seen that a CT image is extracted from the CT image sequence every 30 CT images and the extracted CT image is determined as a sampled image. Then, different image regions in the sampled image are labeled through the neural network, so as to judge whether the sampled image contains an image region with the target image feature, for example, whether there is an image region of a hip bone structure (an image feature class) in the sampled image. In this way, it is possible to quickly locate the starting and ending range of the CT image that characterizes the hip bone structure, that is, it is possible to quickly locate the image sequence section where the target image is located. In some embodiments, it is also possible to appropriately extend the range of the image sequence section to ensure that complete CT images characterizing the hip bone structure are obtained. Herein, the hip bone structure includes a left femur head structure, a right femur head structure and a vertebral structure that are adjacent to hip bones.

In this way, when determining the target image in the image sequence, the images in the image sequence are sampled to select some images from the image sequence for image feature extraction. Then, the target image sequence section where the target image with the target image feature is located is determined, and thus the workload of image processing is reduced and the efficiency of image processing is improved.

Step S13, determining an image region corresponding to each image feature class in the target image sequence section by segmenting the target image in the target image sequence section.

In such a manner, image regions of different image feature classes in the target image may be automatically segmented.

In some embodiments of the disclosure, image region division is performed on the target image in the target image sequence through the neural network, so as to determine the image region corresponding to each image feature class in the target image in the target image sequence section. For example, one or more target images in the target image sequence section are used as an input of the neural network. Then the neural network outputs an image feature class that each pixel in the target image belongs to. Based on pixels corresponding to multiple image feature classes, image regions corresponding to one or more image feature classes in the target image are determined. Herein, the image feature class represents each class of image features of the target image, and the target image features of the target image include multiple classes of image features. That is, it can be seen that the target image feature includes multiple sub-image features and each of the image sub-features corresponds to an image feature class. For example, the target image is a CT image with a pelvic feature, and the image feature class is a left hip bone feature class, a right hip bone feature class, a left femur feature class, a right femur feature class or a vertebral feature class, etc., which are included in the pelvic bone feature. In a process of segmenting different skeletal regions in the CT image with the pelvic feature in the target image sequence section, pixels in the CT image belonging to the left hip bone feature class, the right hip bone feature class, the left femur feature class, the right femur feature class and the vertebral feature class are determined respectively. Then, according to the pixels corresponding to one or more image feature classes, the CT image is segmented into image regions of five skeletons, i.e., a left hip bone region (an image region formed by the pixels of the left hip bone feature class), a right hip bone region (an image region formed by the pixels of the right hip bone feature class), a left femur region (an image region formed by the pixels of the left femur feature class), a right femur region (an image region formed by the pixels of the right femur feature class) and a vertebral region (an image region formed by the pixels of the vertebral feature class).

Thus, one or more different regions among the left hip bone region, right hip bone region, left femur region, right femur region and vertebral region in the CT image may be segmented.

In some embodiments of the disclosure, in a process of segmenting the target image in the target image sequence section to determine the image region corresponding to each image feature class in the target image sequence section, to determine the image region corresponding to each image feature class in the target image in the target image sequence section, the target image in the target image sequence section is segmented based on the target image in the target image sequence section and preset relative position information. Herein, in an image region division process of the target image in the target image sequence section, errors in image region division are reduced by combining the preset relative position information. The relative position information indicates a rough orientation of an image region corresponding to an image feature class in the image, for example, the left hip bone structure is in a left-side region of the image and the right hip bone structure is in a right-side region of the image. Therefore, according to the relative position relationship, if the image area corresponding to the image feature class of the obtained left hip bone structure is located in the right area of the image, it can be determined that the result is wrong. In some embodiments, the target image in the image sequence section may be matched with a preset image sequence section corresponding to one or more image feature classes in the preset image, and then the image region corresponding to the one or more image feature classes in the target image is determined according to a matching result. For example, under the condition that the matching result is greater than 75%, it may be considered that the image region of the target image corresponds to the image feature class of the preset image sequence section.

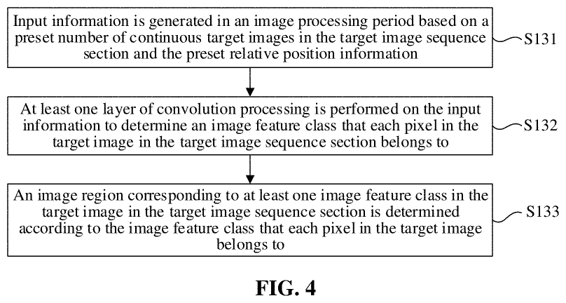

FIG. 4 illustrates a flowchart of determining an image region corresponding to each image feature class in a target image according to embodiments of the disclosure.

In some embodiments of the disclosure, as illustrated in FIG. 4, S13 comprises following steps:

Step S131, generating input information in an image processing period based on a preset number of continuous target images in the target image sequence section and the preset relative position information.

Step S132, performing at least one layer of convolution processing on the input information to determine an image feature class that each pixel in the target image in the target image sequence section belongs to.

Step S133, determining an image region corresponding to the at least one image feature class in the target image in the target image sequence section according to the image feature class that each pixel in the target image belongs to.

In such a manner, the input target images are continuous target images, so that not only the efficiency of image processing can be improved, but also information of association between the target images may be considered.

In some embodiments of the disclosure, the image region corresponding to the one or more image feature classes in the target image is determined through the neural network, thereby dividing different image regions in the target image. The target image in the image sequence section and the relative position information are used as the input of the neural network, so that the input information for the neural network is generated from the target image and the relative position information. Then at least one layer of convolution processing is performed on the input information through the neural network and the image feature class that the pixel in the target image belongs to is an output of the neural network. Herein, the image processing period is a processing period corresponding to one round of input-and-output of the neural network. In an image processing period, the target image input to the neural network is a preset number of continuous target images, for example, five continuous target images with a size of 512*512*1 cm³ are determined as the input of the neural network. Herein, “continuous” means that the target images are arranged positionally adjacently in the image sequence. Since the input target images are continuous target images, compared with processing only one target image in an image processing period, not only the efficiency of image processing is improved, but also the accuracy of target image segmentation is improved by considering information of association between the target images, for example, association between the target images includes positions of image regions corresponding to an image feature class are substantially the same in the multiple target images, or position changes of image regions corresponding to an image feature class are continuous in the multiple target images. Herein, the relative position information includes information of a relative position in an x direction and a relative position in a y direction. The information of the relative position in the x direction is indicated by an x map, and the position of the relative position in the y direction is indicated by a y map. Sizes of the x map and the y map may be the same as a size of the target image. A feature value of a pixel in the x map indicates a relative position of the pixel in the x direction, and a feature value of a pixel in the y map indicates a relative position of the pixel in the y direction. In this way, the relative position information is used to make the image feature class determined by the neural network after the classification of multiple pixels have a priori information. For example, if a feature value of a pixel in the x map is −1, it indicates that the pixel is on a left side of the target image, and an obtained classification result should be an image feature class corresponding to the left-side image region. In one embodiment of the disclosure, the neural network is a convolutional neural network and includes multiple intermediate layers, and each intermediate layer corresponds to a layer of convolution processing. The image feature class that the pixel in the target image belongs to may be determined by use of the neural network, so that the image region formed by the pixels belonging to one or more image feature classes may be determined to implement segmentation of different image regions in the target image.

In one embodiment of the disclosure, the convolution processing in the neural network may include down-sampling operation and up-sampling operation, the performing the at least one layer of convolution processing on the input information to determine the image feature class that each pixel in the target image belongs to comprises: obtaining a feature map input for down-sampling operation based on the input information; down-sampling the feature map input for the down-sampling operation to obtain a first feature map output by the down-sampling operation; obtaining, based on the first feature map output by the down-sampling operation, a feature map input for the up-sampling operation; up-sampling the feature map input for the up-sampling operation to obtain a second feature map output by the up-sampling operation; and determining the image feature class that each pixel in the target image belongs to based on a second feature map output by a final layer of up-sampling operation.

In the embodiment of the disclosure, the convolution processing of the neural network may include down-sampling operation and up-sampling operation, and an input for the down-sampling operation may be a feature map obtained based on a previous layer of convolution processing. As to a feature map input for a layer of down-sampling operation, after performing down-sampling operation on this feature map, a first feature map is obtained after this layer of down-sampling operation. Sizes of first feature maps obtained by different layers of the down-sampling operation are different. After multiple layers of the down-sampling operation are executed on the input information, a first feature map output by a final layer of down-sampling operation among the multiple layers of down-sampling operations is used as a feature map input for the up-sampling operation, or, a feature map obtained by performing convolution processing on the first feature map output by the final layer of down-sampling operation is used as the feature map input for the up-sampling operation. Correspondingly, an input for the up-sampling operation may be a feature map obtained based on a previous layer of convolution processing. As to a feature map input for a layer of up-sampling operation, after performing up-sampling operation on this feature map, up-sample a second feature map is obtained after this layer of up-sampling operation. Herein, the number of down-sampling operation layers is the same as that of up-sampling operation layers, and the neural network has a symmetric structure. Then, the image feature class that each pixel in the target image belongs to is obtained according to a second feature map output by a final layer of up-sampling operation. For example, other processing, such as convolution processing and normalization processing, are performed on the second feature map output by the final layer of up-sampling operation to obtain the image feature classes that one or more pixels in the target image belong to.

In order to combine local detail information and global information of the target image, atrous convolution operation is executed on the first feature map output by the down-sampling operation to obtain the feature map input for the up-sampling operation. In this way, the feature map input for the up-sampling operation includes more global information of the target image, which improves the accuracy of the obtained image feature class that each pixel belongs to. The following is an example to illustrate the atrous convolution operation.

In the embodiment of the disclosure, the convolution processing includes atrous convolution operation, and obtaining the feature map input for the up-sampling operation based on the first feature map output by the down-sampling operation comprises: down-sampling obtaining a feature map input for at least one layer of atrous convolution operation based on a first feature map output by a final layer of down-sampling operation; executing the at least one layer of atrous convolution operation on the feature map input for the at least one layer of atrous convolution operation to obtain a third feature map after the atrous convolution operation, wherein a size of the third feature map obtained by means of the atrous convolution operation decreases as a number of atrous convolution operation layers increases; and obtaining, according to the third feature map obtained by means of the atrous convolution operation, the feature map input for the up-sampling operation.

In the embodiment of the disclosure, the convolution processing in the neural network includes atrous convolution operation, and the atrous convolution operations include multiple layers. An input of the atrous convolution operation with the multiple layers is the first feature map output by the final layer of down-sampling operation, or, is a feature map obtained by performing at least one layer of convolution operation on the first feature map output by the final layer of down-sampling operation. An input for a layer of atrous convolution operation is a feature map obtained based on a previous layer of convolution processing. As to a feature map input for a layer of atrous convolution operation, atrous convolution operation may be performed on the feature map to obtain a third feature map after this layer of atrous convolution operation, and the feature map input for the up-sampling operation is obtained according to third feature maps obtained by the multiple layers of the atrous convolution operation. The atrous convolution operation reduces the loss of information in the input feature map occurred during convolution process and increases the region of the target image mapped by the pixels in the first feature map, so that relevant information is remained as much as possible and the finally determined image region is more accurate.

In such a manner, local detail information and global information of the target image may be combined to enable the finally determined image region to be more accurate.

In one embodiment of the disclosure, when obtaining the feature map input for the up-sampling operation according to the third feature map obtained by means of the atrous convolution operation, a first fusion feature map is obtained by performing feature fusion on a plurality of third feature maps obtained by the at least one layer of atrous convolution operation, and the feature map input for the up-sampling operation is obtained based on the first fusion feature map. Herein, a respective third feature map may be obtained by a layer of atrous convolution operation, and sizes of the multiple third feature maps obtained by the multiple layers of the atrous convolution operation decreases as the number of atrous convolution operation layers increases. That is, the size of the obtained third feature map is smaller if the layer of atrous convolution operation is higher, so that the multiple third feature maps obtained by the multiple layers of the atrous convolution operation is considered to form a pyramid structure. As the size of the third feature map continues to decrease, some related information will be lost, so that multiple third feature maps obtained by the multi-level atrous convolution operation are fused to obtain the first fusion feature map. The first fusion feature map includes more global information of the target image. Then the feature map input for the up-sampling operation is obtained according to the first fusion feature map. For example, the first fusion feature map is used as the feature map input for the up-sampling operation, or, convolution operation is performed on the first fusion feature map and a feature map obtained by the convolution operation is used as the feature map input for the up-sampling operation. In this way, the feature map input for the up-sampling operation includes more global information of the target image, and the accuracy of the obtained image feature class that each pixel belongs to is improved.

In one embodiment of the disclosure, the obtaining the feature map input for the up-sampling operation based on the first feature map output by the down-sampling operation comprises: in the case that current up-sampling operation is a first layer of up-sampling operation, obtaining the feature map input for the current up-sampling operation according to the first feature map output by the final layer of down-sampling operation; in the case that the current up-sampling operation is a second or higher layer of up-sampling operation, fusing a second feature map output by a previous layer of up-sampling operation and a first feature map that is matched with and in a same feature map size as the second feature map output by the previous layer of up-sampling operation, to obtain a second fusion feature map; current up-sampling operation and obtaining, based on the second fusion feature map, the feature map input for the current up-sampling operation.

In the embodiment of the disclosure, when the current up-sampling operation is the first layer of up-sampling operation, the feature map output by a previous layer of convolution operation is used as the feature map input for the first layer of up-sampling operation. For example, the first fusion feature map obtained by the multiple layers of the atrous convolution operation is used as the feature map input for the first layer of up-sampling operation, or convolution operation is performed on the first fusion feature map to obtain the feature map input for the first layer of up-sampling operation. When the current up-sampling operation is a second or higher layer of up-sampling operation, the second feature map output by the previous layer of up-sampling operation of the current up-sampling operation and the first feature map matching with the second feature map with the same feature map size are fused to obtain a second fusion feature map. The feature map input for the current up-sampling operation is obtained based on the second fusion feature map. For example, the second fusion feature map is used as the feature map input for the current up-sampling operation, or, at least one layer of convolution operation is performed on the second fusion feature map to obtain the feature map input for the current up-sampling operation. In this way, the feature map input for the current up-sampling operation contains the local detail information and global information of the target image.

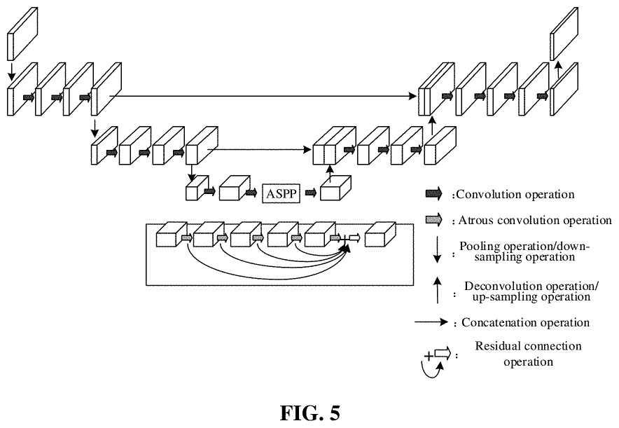

FIG. 5 illustrates a block diagram of an example of a neural network structure according to embodiments of the disclosure.

A network structure of the neural network will be described below in combination with an example. The network structure of the neural network is a U network structure, a V network structure or a fully convolutional network structure. As illustrated in FIG. 5, the network structure of the neural network is symmetric. The neural network performs multiple layers of convolution processing on the input target image, and the convolution processing includes convolution operation, up-sampling operation, down-sampling operation, atrous convolution operation, concatenation operation and addition operation. Wherein, ASPP indicates an Atrous Spatial Pyramid Pooling module, and convolution processing in the ASPP module includes the atrous convolution operation and residual connection operation. Five continuous target images with a size of 512*512*1 is used as an input for the neural network. The relative position information, i.e., the x map and the y map, are combined at the same time, that is, two input channels are added, and there are 7 input channels in total. Through different layers of convolution operation, three times of down-sampling or pooling operation, normalization operation and activation operation, a size of a feature map obtained from the target images is reduced to 256*256 and then 128*128, and a feature map with 64*64 pixels is finally obtained. At the same time, the number of channels is increased from 7 to 256, and the obtained feature map is processed through the APSS module, that is, through the connection operation of the atrous convolution and the spatial pyramid structure, as much as possible of the relevant information of the target image is retained. After three deconvolution operations or up-sampling operations, the feature map with a size of 64*64 is gradually increased to 512*512, which is the same size as the target image. In the deconvolution operation or up-sampling operation, the feature map with the same size obtained by the down-sampling or pooling operation are fused with the feature map with the same size obtained by the deconvolution operation or the up-sampling operation, and a fusion feature map obtained in such a manner contains local detail information and global information of the target image. Then, three times of different convolution operation is executed to obtain an image feature class that each pixel in the target image belongs to, to implement segmentation of different image regions of the target image.

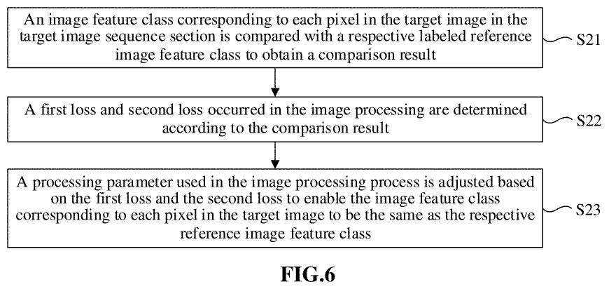

FIG. 6 illustrates a flowchart of an example of training the neural network according to embodiments of the disclosure.

In such a manner, through the up-sampling operation and the down-sampling operation, an image feature of the target image may be extracted accurately, so that the image feature class that each pixel belong to may be obtained.

In one embodiment of the disclosure, a process of training the neural network by use of a determined classification result of each pixel of the target image after the neural network determines the image region corresponding to each image feature class in the target image is described. As illustrated in FIG. 6, after S13, the method further comprises:

Step S21, comparing an image feature class corresponding to each pixel in the target image in the target image sequence section with a respective labeled reference image feature class to obtain a comparison result.

Step S22, determining, according to the comparison result, a first loss and a second loss occurred in the image processing.

Step S23, adjusting, based on the first loss and the second loss, a processing parameter used in the image processing, to enable the image feature class corresponding to each pixel in the target image to be the same as the respective reference image feature class.

Herein, the target image is a training sample used for training the neural network. The image feature class of one or more pixels in the target image is pre-labeled, and the pre-labeled image feature class is the reference image feature class. After the image region corresponding to the at least one image feature class in the target image is determined through the neural network, the image feature class corresponding to one or more pixels in the target image is compared with the labeled reference image feature class. During comparison, different loss functions are used to obtain a comparison result, for example, a cross entropy loss function, a Dice loss function, a mean square error loss, etc., or, multiple loss functions are combined to obtain a joint loss function. The first loss and second loss caused in the image processing are determined according to the comparison results obtained by different loss functions, and the determined first loss and second loss are combined to adjust the processing parameter used by the neural network, so that the image feature class corresponding to each pixel of the target image is the same as the labeled reference image feature class, thus completing the training process of the neural network.

In such a manner, the processing parameter used by a neural network may be adjusted through multiple losses, achieving a better training effect for the neural network.

In one embodiment of the disclosure, the adjusting, based on the first loss and the second loss, the processing parameter used in the image processing comprises: acquiring a first weight corresponding to the first loss and a second weight corresponding to the second loss; obtaining a target loss by weighting the first loss and the second loss based on the first weight and the second weight; and adjusting, based on the target loss, the processing parameter used in the image processing.

Herein, when adjusting the processing parameter of the neural network based on the first loss and the second loss, the weight values of the first loss and the second loss are set separately according to the actual application scenario, for example, the first loss is set to a first weight of 0.8 and the second weight of 0.2 for the second loss to get the final target loss. Then, the processing parameter of the neural network is updated based on the target loss by means of back propagation to iteratively optimize the neural network to obtain a trained neural network until the target loss of the neural network converges or a maximum iteration count is reached.

In such a manner, weight values may be set for the first loss and the second loss respectively according to a practical application scenario, achieving a better training effect for the neural network.

The image processing solution provided in the embodiments of the disclosure is applied to segmentation of different skeletal regions in the CT image sequence, for example, segmentation of different skeletons of the pelvic structure. The CT images in the CT image sequence are sampled and combined with the relative position information in the cross section, to determine upper and lower boundaries of the CT images representing the pelvic region in the CT image sequence through the neural network, namely, determining the target image sequence section of the pelvic CT image. Then, the pelvic CT image in the target image sequence section is segmented based on the obtained target image sequence section of the pelvic CT image. For example, the target image is segmented into the image regions of the five skeletons, i.e., a left hip bone region, a right hip bone region, a left femur region, a right femur region and a vertebral region. Compared with existing methods of roughly segmenting the pelvic region, i.e., a segmentation method where the five skeletons are not distinguished, the image processing solution provided in the embodiments of the disclosure accurately distinguish the five bones included in the pelvic region, which is more conducive to judgment. The location of the pelvic tumor facilitates the planning of surgery. At the same time, rapid pelvic region positioning is achieved (the image processing solution provided by the embodiments of the present disclosure generally takes 30 seconds to segment the pelvic region, and the related segmentation method requires ten minutes or even several hours).

It can be understood that each method embodiment mentioned in the disclosure may be combined to form combined embodiments without departing from principles and logics. For saving the space, elaborations are omitted in the disclosure.

In addition, the disclosure also provides a device for image processing, an electronic device, a computer-readable storage medium and a program. All of them may be configured to implement any method for image processing provided in the disclosure. Corresponding technical solutions and descriptions refer to the corresponding records in the method part and will not be elaborated.

It can be understood by those skilled in the art that, in the method of the specific implementations, the writing sequence of each step does not mean a strict execution sequence and is not intended to form any limit to the implementation process and a specific execution sequence of each step should be determined by functions and probable internal logic thereof.

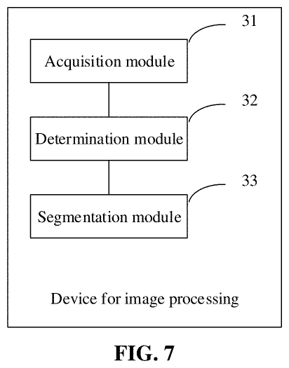

FIG. 7 illustrates a block diagram of a device for image processing according to embodiments of the disclosure. As illustrated in FIG. 7, the device for image processing includes an acquisition module 31, a determination module 32 and a segmentation module 33.

The acquisition module 31 is configured to acquire an image sequence to be processed. The determination module 32 is configured to obtain a target image sequence section by determining, in the image sequence to be processed, an image sequence section where a target image is located. The segmentation module 33 is configured to determine an image region corresponding to at least one image feature class in the target image sequence section by segmenting the target image in the target image sequence section.

In one embodiment of the disclosure, the determination module 32 is specifically configured to: determine a sampling step length for the image sequence to be processed; obtain sampled images by acquiring images from the image sequence to be processed according to the sampling step length; determine a sampled image with a target image feature according to image features of the sampled images; and obtain the target image sequence section by determining, according to a position where the sampled image with the target image feature is arranged in the image sequence, the image sequence section where the target image is located.

In one embodiment of the disclosure, the segmentation module 33 is specifically configured to: determine the image region corresponding to the at least one image feature class in the target image in the target image sequence section by segmenting the target image in the target image sequence section based on the target image in the target image sequence section and preset relative position information.

In one embodiment of the disclosure, the segmentation module 33 is specifically configured to: generate input information in an image processing period based on a preset number of continuous target images in the target image sequence section and the preset relative position information; perform at least one layer of convolution processing on the input information to determine an image feature class that each pixel in the target image in the target image sequence section belongs to; and determine the image region corresponding to the at least one image feature class in the target image in the target image sequence section according to the image feature class that each pixel in the target image belongs to.

In one embodiment of the disclosure, the convolution processing includes up-sampling operation and down-sampling operation. The segmentation module 33 is specifically configured to: obtain, based on the input information, a feature map input for the down-sampling operation; down-sample the feature map input for the down-sampling operation to obtain a first feature map output by the down-sampling operation; obtain, based on the first feature map output by the down-sampling operation, a feature map input for the up-sampling operation; up-sample the feature map input for the up-sampling operation to obtain a second feature map output by the up-sampling operation; and determine the image feature class that each pixel in the target image belongs to based on a second feature map output by a final layer of up-sampling operation.

In one embodiment of the disclosure, the convolution processing further includes atrous convolution operation. The segmentation module 33 is specifically configured to: obtain, based on a first feature map output by a final layer of down-sampling operation, a feature map input for at least one layer of atrous convolution operation; execute the at least one layer of atrous convolution operation on the feature map input for the at least one layer of atrous convolution operation, to obtain a third feature map after the atrous convolution operation, with a size of the third feature map obtained by means of the atrous convolution operation decreasing as increase of a number of atrous convolution operation layers; and obtain, according to the third feature map obtained by means of the atrous convolution operation, the feature map input for the up-sampling operation.

In one embodiment of the disclosure, the segmentation module 33 is specifically configured to: perform feature fusion on multiple third feature maps obtained by the at least one layer of atrous convolution operation, to obtain a first fusion feature map; and obtain, based on the first fusion feature map, the feature map input for the up-sampling operation.

In one embodiment of the disclosure, the segmentation module 33 is specifically configured to: in the case that current up-sampling operation is a first layer of up-sampling operation, obtaining the feature map input for the current up-sampling operation according to a first feature map output by a final layer of down-sampling operation; or in the case that the current up-sampling operation is a second or higher layer of up-sampling operation, fusing a second feature map output by a previous layer of up-sampling operation and a first feature map that is matched with and in a same feature map size as the second feature map output by the previous layer of up-sampling operation, to obtain a second fusion feature map, and obtaining, based on the second fusion feature map, the feature map input for the current up-sampling operation.

In one embodiment of the disclosure, the device further includes: a training module, configured to compare an image feature class corresponding to each pixel in the target image in the target image sequence section with a respective labeled reference image feature class to obtain a comparison result; determine, according to the comparison result, a first loss and a second loss occurred in the image processing; and adjust, based on the first loss and the second loss, a processing parameter used in the image processing, to enable the image feature class corresponding to each pixel in the target image to be the same as the respective reference image feature class.

In one embodiment of the disclosure, the training module is specifically configured to: acquire a first weight corresponding to the first loss and a second weight corresponding to the second loss; obtain a target loss by weighting the first loss and the second loss based on the first weight and the second weight; and adjust, based on the target loss, the processing parameter used in the image processing process.

In one embodiment of the disclosure, the device further includes: a preprocessing module, configured to acquire an image sequence formed by images that are acquired in a preset acquisition period, and preprocess the image sequence to obtain the image sequence to be processed.

In one embodiment of the disclosure, the preprocessing module is specifically configured to: perform direction correction on each image in the image sequence to obtain the image sequence to be processed according to a respective direction identifier of the image in the image sequence.

In one embodiment of the disclosure, the preprocessing module is specifically configured to: convert the images in the image sequence into images with a preset size; and obtain the image sequence to be processed by cropping the images with the preset size to maintain center parts of the images.

In one embodiment of the disclosure, the target image is a pelvic computed tomography (CT) image, and the image region includes one or more of: a left hip bone region, a right hip bone region, a left femur region, a right femur region and a vertebral region.

In some embodiments, functions or modules of the device provided in the embodiments of the disclosure may be configured to execute the method described in the above method embodiment, and specific implementation thereof may refer to the description about the method embodiment and will not be elaborated herein for simplicity.

In the embodiments of the disclosure, also provided is an electronic device, which includes a processor and a memory configured to store processor-executable instructions. The processor being configured to perform the method above.

The electronic device may be provided as a terminal, a server or a device in another form.

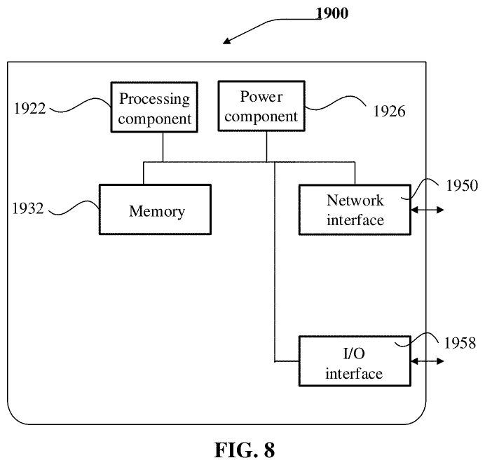

FIG. 8 illustrates a block diagram of an electronic device 1900 according to an exemplary embodiment. For example, the electronic device 1900 may be provided as a server. Referring to FIG. 8, the electronic device 1900 includes: a processing component 1922, further including one or more processors; and a memory resource represented by a memory 1932, configured to store instructions executable for the processing component 1922, for example, an application. The application stored in the memory 1932 may include one or more modules each corresponding to a set of instructions. In addition, the processing component 1922 is configured to execute the instructions to perform the method above.

The electronic device 1900 may further include: a power component 1926 configured to execute power management of the electronic device 1900, a wired or wireless network interface 1950 configured to connect the electronic device 1900 to a network, and an Input/Output (I/O) interface 1958. The electronic device 1900 may be operated based on an operating system stored in the memory 1932, for example, Windows Server™, Mac OS X™, Unix™, Linux™, FreeBSD™ or other operating systems.

In exemplary embodiments, a nonvolatile or volatile computer-readable storage medium is also provided, for example, a memory 1932 including computer program instructions. The computer program instructions may be executed by a processing component 1922 of an electronic device 1900 to implement the method above.

In the embodiments of the disclosure, also provided is a computer program including a computer-readable code which, when running in an electronic device, enables a processor in the electronic device to execute the method above.

The disclosure may be realized as a system, a method and/or a computer program product. The computer program product may include a computer-readable storage medium stored with computer-readable program instructions configured to enable a processor to implement each aspect of the disclosure.

The computer-readable storage medium may be a tangible device capable of retaining and storing instructions to be used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a Read-Only Memory (ROM), an Erasable Programmable ROM (EPROM, or a flash memory), a Static RAM (SRAM), a Compact Disc Read-Only Memory (CD-ROM), a Digital Video Disk (DVD), a memory stick, a floppy disk, a mechanical encoding device, a punched card or in-slot raised structure with an instructions stored therein, and any appropriate combination thereof. The computer-readable storage medium used herein is not explained as a transient signal, for example, radio waves or another freely propagating electromagnetic waves, an electromagnetic wave propagating through a wave guide or another transmission medium (for example, optical pulses propagating through an optical fiber cable) or an electric signal transmitting through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instructions from the network and forwards the computer-readable program instructions for storing in the computer-readable storage medium in each computing/processing device.

The computer program instructions configured to execute the operations of the disclosure may be assembly instructions, Instruction Set Architecture (ISA) instructions, machine instructions, machine related instructions, micro-codes, firmware instructions, state setting data, or source codes or target codes edited by one or any combination of more programming languages. The programming languages include an object-oriented programming language such as Smalltalk and C++, and a conventional procedural programming language such as “C” language or similar programming languages. The computer-readable program instructions may be completely or partially executed in a computer of a user, executed as an independent software package, executed partially in the computer of the user and partially in a remote computer, or executed completely in the remote server or a server. Under the condition that a remote computer is involved, the remote computer may be connected to the computer of the user through any type of network including an LAN or a WAN, or, may be connected to an external computer (for example, connected by an Internet service provider through the Internet). In some embodiments, an electronic circuit such as a programmable logic circuit, a Field-Programmable Gate Array (FPGA) or a Programmable Logic Array (PLA), may be customized by use of state information of computer-readable program instructions, and the electronic circuit may execute the computer-readable program instructions, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of blocks in the flowcharts and/or the block diagrams may be implemented by computer-readable program instructions.

These computer-readable program instructions may be provided to a universal computer, a dedicated computer or a processor of another programmable data processing device, thereby producing a machine, i.e., a device that realizes a function/action specified in one or more blocks in the flowcharts and/or the block diagrams when the instructions are executed through the processor of the computer or the other programmable data processing devices. These computer-readable program instructions may also be stored in a computer-readable storage medium, to enable the computer, the programmable data processing device and/or another device to operate in a specific manner Therefore, the computer-readable medium stored with the instructions includes a product including instructions for implementing each aspect of the function/action specified in one or more blocks in the flowcharts and/or the block diagrams.

These computer-readable program instructions may further be loaded to the computer, the other programmable data processing devices, or the other device, so that a series of operating steps are executed in the computer, the other programmable data processing device or the other device to generate a process implemented by the computer, to further realize the function/action specified in one or more blocks in the flowcharts and/or the block diagrams by the instructions executed in the computer, the other programmable data processing device or the other device.

The flowcharts and block diagrams in the drawings illustrate possibly implementable architectures, functions and operations of the system, method and computer program product according to multiple embodiments of the disclosure. On this aspect, each block in the flowcharts or the block diagrams may represent part of a module, a program segment or instructions, and part of the module, the program segment or the instructions includes one or more executable instructions configured to realize a specified logical function. In some alternative implementations, the functions marked in the blocks may also be realized in a sequence different from those marked in the drawings. For example, two continuous blocks may actually be executed substantially concurrently or may also be executed in a reverse sequence sometimes, which is determined by the involved functions. It is further to be noted that each block in the block diagrams and/or the flowcharts, and a combination of the blocks in the block diagrams and/or the flowcharts may be implemented by a dedicated hardware-based system configured to execute a specified function or operation or may be implemented by a combination of a special hardware and computer instructions.

Various embodiments of the disclosure have been described above. The above description is exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of various embodiments, or technical improvements thereof for the technologies in the market best, or to enable others of ordinary skill in the art to understand the embodiments disclosed herein.

1. A method for image processing, comprising:
acquiring an image sequence to be processed;
obtaining a target image sequence section by determining, in the image sequence to be processed, an image sequence section where a target image is located; and
determining an image region corresponding to at least one image feature class in the target image sequence section by segmenting the target image in the target image sequence section.

2. The method of claim 1, wherein obtaining the target image sequence section by determining, in the image sequence to be processed, the image sequence section where the target image is located comprises:
determining a sampling step length for the image sequence to be processed;
obtaining sampled images by acquiring images from the image sequence to be processed according to the sampling step length;
determining a sampled image with a target image feature according to image features of the sampled images; and
obtaining the target image sequence section by determining, according to a position where the sampled image with the target image feature is arranged in the image sequence, the image sequence section where the target image is located.

3. The method of claim 1, wherein determining the image region corresponding to the at least one image feature class in the target image sequence section by segmenting the target image in the target image sequence section comprises:
determining the image region corresponding to the at least one image feature class in the target image in the target image sequence section by segmenting the target image in the target image sequence section based on the target image in the target image sequence section and preset relative position information.

4. The method of claim 3, wherein determining the image region corresponding to the at least one image feature class in the target image in the target image sequence section by segmenting the target image in the target image sequence section based on the target image in the target image sequence section and the preset relative position information comprises:
generating input information in an image processing period based on a preset number of continuous target images in the target image sequence section and the preset relative position information;
performing at least one layer of convolution processing on the input information to determine an image feature class that each pixel in the target image in the target image sequence section belongs to; and
determining the image region corresponding to the at least one image feature class in the target image in the target image sequence section according to the image feature class that each pixel in the target image belongs to.

5. The method of claim 4, wherein the convolution processing comprises up-sampling operation and down-sampling operation, and performing the at least one layer of convolution processing on the input information to determine the image feature class that each pixel in the target image belongs to comprises:
obtaining, based on the input information, a feature map input for the down-sampling operation;
down-sampling the feature map input for the down-sampling operation to obtain a first feature map output by the down-sampling operation;
obtaining, based on the first feature map output by the down-sampling operation, a feature map input for the up-sampling operation;
up-sampling the feature map input for the up-sampling operation to obtain a second feature map output by the up-sampling operation; and
determining the image feature class that each pixel in the target image belongs to based on a second feature map output by a final layer of up-sampling operation.

6. The method of claim 5, wherein the convolution processing further comprises atrous convolution operation, and obtaining, based on the first feature map output by the down-sampling operation, the feature map input for the up-sampling operation comprises:
obtaining, based on a first feature map output by a final layer of down-sampling operation, a feature map input for at least one layer of atrous convolution operation;
executing the at least one layer of atrous convolution operation on the feature map input for the at least one layer of atrous convolution operation to obtain a third feature map after the atrous convolution operation, wherein a size of the third feature map obtained by means of the atrous convolution operation decreases as a number of atrous convolution operation layers increases; and
obtaining, according to the third feature map obtained by means of the atrous convolution operation, the feature map input for the up-sampling operation.

7. The method of claim 6, wherein obtaining, according to the third feature map obtained by means of the atrous convolution operation, the feature map input for the up-sampling operation comprises:
performing feature fusion on a plurality of third feature maps obtained by the at least one layer of atrous convolution operation, to obtain a first fusion feature map; and
obtaining, based on the first fusion feature map, the feature map input for the up-sampling operation.

8. The method of claim 5, wherein obtaining, based on the first feature map output by the down-sampling operation, the feature map input for the up-sampling operation comprises:
in the case that a current up-sampling operation is a first layer of up-sampling operation, obtaining the feature map input for the current up-sampling operation according to the first feature map output by the final layer of down-sampling operation;
in the case that the current up-sampling operation is a second or higher layer of up-sampling operation, fusing a second feature map output by a previous layer of up-sampling operation and a first feature map that is matched with and in a same feature map size as the second feature map output by the previous layer of up-sampling operation, to obtain a second fusion feature map; and
obtaining, based on the second fusion feature map, the feature map input for the current up-sampling operation.

9. The method of claim 1, wherein after determining the image region corresponding to the at least one image feature class in the target image sequence section, the method further comprises:
comparing an image feature class corresponding to each pixel in the target image in the target image sequence section with a respective labeled reference image feature class to obtain a comparison result;
determining, according to the comparison result, a first loss and a second loss occurred in the image processing; and
adjusting, based on the first loss and the second loss, a processing parameter used in the image processing, to enable the image feature class corresponding to each pixel in the target image to be the same as the respective labeled reference image feature class.

10. The method of claim 9, wherein adjusting, based on the first loss and the second loss, the processing parameter used in the image processing comprises:
acquiring a first weight corresponding to the first loss and a second weight corresponding to the second loss;
obtaining a target loss by weighting the first loss and the second loss based on the first weight and the second weight; and
adjusting, based on the target loss, the processing parameter used in the image processing.

11. The method of claim 1, wherein before the acquiring the image sequence to be processed, the method further comprises:
acquiring an image sequence formed by images that are acquired in a preset acquisition period; and
preprocessing the image sequence to obtain the image sequence to be processed.

12. The method of claim 11, wherein preprocessing the image sequence to obtain the image sequence to be processed comprises:
performing direction correction on each image in the image sequence to obtain the image sequence to be processed according to a respective direction identifier of the image in the image sequence.

13. The method of claim 12, wherein preprocessing the image sequence to obtain the image sequence to be processed comprises:
converting the images in the image sequence into images with a preset size; and
obtaining the image sequence to be processed by performing center cropping on the images with the preset size.

14. The method of claim 1, wherein the target image is a pelvic computed tomography (CT) image, and the image region comprises one or more of: a left hip bone region, a right hip bone region, a left femur region, a right femur region and a vertebral region.

15. An electronic device, comprising:
a processor; and
a memory, configured to store processor-executable instructions,
wherein the processor is configured to call the processor-executable instructions stored in the memory to:
acquire an image sequence to be processed;
obtain a target image sequence section by determining, in the image sequence to be processed, an image sequence section where a target image is located; and
determine an image region corresponding to at least one image feature class in the target image sequence section by segmenting the target image in the target image sequence section.

16. The electronic device of claim 15, wherein in obtaining the target image sequence section by determining, in the image sequence to be processed, the image sequence section where the target image is located, the processor is configured to call the processor-executable instructions stored in the memory to:
determine a sampling step length for the image sequence to be processed;
obtain sampled images by acquiring images from the image sequence to be processed according to the sampling step length;
determine a sampled image with a target image feature according to image features of the sampled images; and
obtain the target image sequence section by determining, according to a position where the sampled image with the target image feature is arranged in the image sequence, the image sequence section where the target image is located.

17. The electronic device of claim 15, wherein in determining the image region corresponding to the at least one image feature class in the target image sequence section by segmenting the target image in the target image sequence section, the processor is configured to call the processor-executable instructions stored in the memory to:
determine the image region corresponding to the at least one image feature class in the target image in the target image sequence section by segmenting the target image in the target image sequence section based on the target image in the target image sequence section and preset relative position information.

18. The electronic device of claim 17, wherein in determining the image region corresponding to the at least one image feature class in the target image in the target image sequence section by segmenting the target image in the target image sequence section based on the target image in the target image sequence section and the preset relative position information, the processor is configured to call the processor-executable instructions stored in the memory to:
generate input information in an image processing period based on a preset number of continuous target images in the target image sequence section and the preset relative position information;
perform at least one layer of convolution processing on the input information to determine an image feature class that each pixel in the target image in the target image sequence section belongs to; and
determine the image region corresponding to the at least one image feature class in the target image in the target image sequence section according to the image feature class that each pixel in the target image belongs to.

19. The electronic device of claim 18, wherein the convolution processing comprises up-sampling operation and down-sampling operation, and in performing the at least one layer of convolution processing on the input information to determine the image feature class that each pixel in the target image belongs to, the processor is configured to call the processor-executable instructions stored in the memory to:
obtain, based on the input information, a feature map input for the down-sampling operation;
down-sample the feature map input for the down-sampling operation to obtain a first feature map output by the down-sampling operation;
obtain, based on the first feature map output by the down-sampling operation, a feature map input for the up-sampling operation;
up-sample the feature map input for the up-sampling operation to obtain a second feature map output by the up-sampling operation; and
determine the image feature class that each pixel in the target image belongs to based on a second feature map output by a final layer of up-sampling operation.

20. A non-transitory computer-readable storage medium having computer program instructions stored thereon, wherein the computer program instructions, when being executed by a processor, cause the processor to implement a method for image processing, the method comprising:
acquiring an image sequence to be processed;
obtaining a target image sequence section by determining, in the image sequence to be processed, an image sequence section where a target image is located; and
determining an image region corresponding to at least one image feature class in the target image sequence section by segmenting the target image in the target image sequence section.
